(19) United States
(12) Patent Application Publication
(10) Pub. No.: US 2007/0103508 A1
(43) Pub. Date: May 10, 2007

(54) Inkjet recording apparatus

(75) Inventor: Tsutomu Yoneyama, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: KONICA MINOLTA MEDICAL & GRAPHIC, INC.

(21) Appl. No.: 11/592,213

(22) Filed: Nov. 3, 2006

(30) Foreign Application Priority Data
Nov. 8, 2005 (JP) JP2005-323494

(51) Int. Cl. B41J 2/15

(52) U.S. Cl. 347/40

(57) ABSTRACT

Inkjet recording apparatus 100 having: rotation drum 3 to rotate while recording medium P is being maintained on a circumference surface of the rotation drum 3; recording head 6 including a plurality of nozzles which is opposite to the circumference surface and arranged along an axis direction of rotation drum 3 to jet ink; and control section 9 to control ink jetting operation while rotation drum 3 is rotating, and to move recording head 6 by a predetermined distance in the axis direction of rotation drum 3 in every single revolution of the rotation drum 3 so that ink jetted form each nozzle do not neighbor each other in the axis direction of rotation drum 3 on recording medium P and ink jetted from recording head 6 do not neighbor each other on recording medium P.

This application is based on Japanese Patent Application No. 2005-323494 filed on Nov. 8, 2005, in Japanese Patent Office, the entire content of which is hereby incorporated by reference.

### BACKGROUND OF THE INVENTION

The present invention relates to an inkjet recording apparatus and in particular to an inkjet recording apparatus having a rotation drum.

An inkjet recording apparatus has been known as a recording apparatus capable of recording on various kinds of recording media represented by a normal paper. The inkjet recording apparatus is a recording apparatus in which nozzles provided on a surface of a recording head opposite to the recording medium jet color material represented by ink directly to the recording medium so as to land in, intrude and fix onto the recording medium, and has superior characteristics in simple process, quietness of operation and printing quality.

Among such inkjet recording apparatuses, so called a serial type is widely used. In the serial type inkjet recording apparatus, a carriage equipped with the recording head to jet ink reciprocates in a main scanning direction and the recording medium is conveyed intermittently in a direction perpendicular to the main scanning direction (sub-scanning direction) for image recording.

Meanwhile, for this serial type inkjet recording apparatus, high quality and high-speed printing are requested by the market and the following problems are occurring to satisfy these demands.

First of all, to reciprocate the carriage, a moving speed of the carriage is accelerated and decelerated when the carriage turns. An acceleration and deceleration area has to be designed within the apparatus in the main scanning direction. Accordingly, the inkjet recording apparatus becomes large in the main-scanning direction.

Also, to increase productivity, there is used, a recording method in which recording is carried out in bi-direction of reciprocation of the carriage, and an operation order of the recording heads is different in a forward stroke and in a backward stroke, so that a problem such banding tends to occur.

Further, a difference of conveyance accuracy occurs according to a thickness of the recording medium to be used then unevenness of conveyance occurs.

Thus, as FIG. 11 shows; there is suggested an drum type inkjet recording apparatus 52 where recording medium P is trained about on drum 50, recording heads 51 are arranged above a circumference surface of drum 50, then ink is jetted onto recording medium P while drum 50 is being rotated so as to record an image. (Patent document 1)

In such drum type inkjet recording apparatus, since recording head 51 is located above the circumference surface of the drum and a width of apparatus in a drum axis direction does not have to be enlarged, main body of the apparatus can be made compact. Also, since image recording is carried out along a circumference direction of the drum, banding occurred by bi-direction recording of serial type inkjet recording apparatus in the course of recording does not occur. Further, once the recording medium is retained by the drum, recording medium P and the drum are not separated while recording an image, thus unevenness of conveyance does not occur.

Here, a printing method of a drum type inkjet recording apparatus is explained. In the drum type inkjet recording apparatus, as FIG. 11 and 12 show, movable head unit 52 where a plurality of recording heads 51 for each color are formed along a drum axis direction (hereinafter called main scanning direction) are configured above the circumference surface of drum 50. Also, in recording head 51, as FIG. 13 shows, nozzles in quantity of N, N₁, N₂, N₃ . . . (N is natural number) are formed in a nozzle pitch 1/Pt (Pₜ=360(dpi), 1/360 inch) and a nozzle array configured by the nozzles in each recording head 51 are corresponding to a width of drum 50 in the main scanning direction.

Here, drafting of an image having a resolution (R_{z}×R_{z}) of 1440 ×1440 (dpi) by using this recording apparatus, is explained as follow.

Firstly, drum 50 is rotated and ink is jetted from nozzles N₁ to Nₙ onto recording medium P.

Here, in case recording is carry out in a circumferential direction of recording medium P on drum 50, ink is jetted in a pitch of 1/1440 inch to form dots on recording medium P. For example, nozzle N₁ jets ink at points when drum 53 rotates 1/1440 inch and forms dots at D₁₁, D₁₂, D₁₃, . . . D₁ (n is a natural number) as FIG. 14 shows. At the same time, ink jetted from nozzle N₂ forms dots at D₅₁, D₅₂, D₅₃, . . . D₅ₙ (n is a natural number) which are 1/360 inch away from D₁₁, D₁₂, D₁₃, . . . D₁ₙ in the main scanning direction.

For example, in case recording head 51 having a driving frequency of 20 kHz, the dots can be formed on recording medium P in a cycle of 50 μ sec, thus drum 50 can be rotated to move recording medium P 1/1440 inch (approx. 17 μm) per 50 μ sec on its circumference surface and can be rotated at a maximum speed of 340 mm/sec.

Then, while drum 50 makes one revolution, head unit 52 intermittently moves for one pitch of the resolution, namely 1/1440 inch in this case. In FIG. 13, nozzle N₁ is moved from a position of nozzle N₁ which is before intermittent conveyance to a position of Ml one which is one pitch of 1440 (dpi) away form the position of N₁ in the main scanning direction. Ink jetted from this position forms a dot at D₂₁ pitch of 1440 (dpi) away from D₁₁ in FIG. 14. By rotating drum 50 continuously nozzle N₁ forms dots at D₂₂, D₂₃ . . . D₂ₙ (n is natural number) which are one pitch of 1440 (dpi) away from D₁₂, D₁₃ . . . D₁ₙ (n is natural number). Meanwhile intermittent feeding of head unit 52 is carried out above the circumference surface,of drum 50 where recording medium P is not retained.

Therefore, in a printing method of a conventional drum type inkjet recording apparatus, the drum is rotated R_{z}/Pₜ times and the head unit is moved R_{z}/Pₜ−1 times, thus printing on whole area of the recording medium becomes possible and a desired image can be obtained. In the aforesaid case, drum 50 rotates 4 times and head unit 52 moves 3 times to obtain the desired image.

Patent Document 1: Japanese Unexamined Patent Application Open to Public Inspection No. H10-138518

However, as stated above, if ink is jetted to fill a space between nozzles i.e. nozzle pitch 1/Pₜ while the drum rotates R_{z}/Pₜ times, all the dots in the space is formed by the ink jetted from the same nozzle. Thus, in FIG. 14, the dots formed by nozzle N1 on recording medium P are D11 to D (R_{Z}/pₜ) ₙ (N is a natural number) and D₁₁ to D₄ₙ (n is a natural number) in the above case. In this case, if nozzle failure is occurred by clogging and other reasons, stripe-shaped unevenness occurs on recording medium P. Also, though the stripe-shaped unevenness does not occur, if jetting ink from a nozzle bends heavily, dots on the recording medium jetted from the nozzle are conspicuous as a line.

Also, in this case, while dots are formed on recording apparatus P in a circumference direction of drum 53, by, jetting ink from the recording head in a pitch of resolution of an image, adjacent dots in the circumference direction stick or reject each other, thus there is a, possibility that a particle condition is deteriorated.

As above, in case the nozzle pitch 1/Pt (distance from a nozzle to a nozzle) is filled with ink jetted by the same nozzle, if nozzle malfunction such as clogging occurs, there was a risk that a high-resolution recording image cannot be obtained.

### SUMMARY OF THE INVENTION

An object of the present invention is to provide a drum type inkjet recording apparatus where a high resolution image can be obtained by forming adjacent dots on a recording medium with ink jetted from different nozzles.

The above problems can be sold by the following structures.

Structure 1: An inkjet recording apparatus, having: a rotation drum to rotate while maintaining a recording medium on a circumference surface; a recording head including a plurality of nozzles opposite to the circumference surface arranged along an axis direction of the rotation drum to jet ink, a control section to control rotation of the rotation drum and ink jetting operation, wherein the recording head moves by a predetermined distance in the axis direction of the rotation drum in every revolution of the rotation drum before ink jetting operation of next revolution so that ink jetted from each nozzle does not neighbor each other in the axis direction of the rotation drum.

According to structure 1, when ink is jetted from the recording head to form dots on the recording medium, the control section controls rotation of the rotation drum and ink jetting operation, wherein the recording head moves a predetermined distance in the axis direction of the rotation drum in every revolution of the rotation drum before ink jetting operation of next revolution so that ink jetted from each nozzle does not neighbor each other in the axis direction of the rotation drum. As a result, the adjacent dots in the axis direction on the recording medium are formed not by ink jetted from the same nozzle and formed by ink jetted from different nozzle.

Structure 2: The inkjet recording apparatus of structure 1, wherein while a nozzle resolution is P_{T} (dpi), a moving distance of the recording head per revolution of the rotation drum is not less than 1/Pₜ.

According to structure 2, the moving distance (intermittent feeding amount) of recording head in the axis direction per revolution of the rotation drum is not less than 1/Pₜ. Thereby adjacent dots on the recording medium cannot be formed by ink jetted form the same nozzle.

Structure 3: The inkjet recording apparatus of structure 1, wherein while a nozzle resolution is P_{T} (dpi), a moving distance of the recording head per revolution of the rotation drum is more than 1/Pₜ.

According to structure 3, the moving distance (intermittent feeding amount) of recording head in the axis direction per revolution of the rotation drum is more than 1/Pₜ. Thereby in case the printing resolution is greater than the nozzle resolution, adjacent dots on the recording medium cannot be formed by ink jetted from the same nozzle.

Structure 4: The inkjet recording apparatus of structure 1, wherein ink jetting timing is controlled so that the recording medium on the rotation drum is filled with dots in a circumference direction by jetting ink from the recording head with a predetermined interval, while the rotation drum rotates a plurality of revolutions.

According to structure 4, by controlling the ink jetting timing, the recording medium is filled by dots in the circumference direction of the rotation drum, while the rotation drum rotates a plurality of revolutions. Namely, when recording is conducted on the recording medium in a condition where the rotation drum rotates continuously, the adjacent dots on the recording medium can be formed in different revolutions of the rotation drum and it can be prevented that the dots formed on the recording medium are formed by ink jetted from the same nozzle.

Structure 5: The inkjet recording apparatus of structure 1, further having a light radiation device above the circumference surface of the rotation drum to harden ink jetted onto the recording medium.

According to structure 5, the recording medium can be irradiated while the rotation drum is rotating.

Structure 6: The inkjet recording apparatus of structure 1, wherein the recording head is moved in the axis direction of the rotation drum, above the circumference surface of the rotation drum where the recording medium is not retained.

According to structure 6, in case a length of recording medium is shorter than a circumference length of the rotation drum, ink jetting operation and moving of the recording head in the axis direction of the rotation drum can be carried out while the rotation drum is rotating continuously.

### BRIEF DESCRIPTION OF THE DRAWINGS

FIG. 1 is a side cross-sectional view showing a schematic structure of an inkjet recording apparatus of a first embodiment.

FIG. 2 is a top view showing a structure of a head unit in FIG. 1.

FIG. 3 is a diagram to explain that the head unit and a light radiation device shift relative to a rotation drum in the embodiment in FIG. 1.

FIG. 4 is a block diagram showing a control structure in Fig. 1.

FIG. 5 is a diagram of dots formed on a recording medium with a predetermined resolution by the embodiment in FIG. 1.

FIG. 6 (a) is a diagram explaining that the head unit moves a distance longer than a nozzle pitch in an axis direction of the rotation drum in every single revolution of the rotation drum.

FIG. 6 (b) is a diagram explaining in what number of revolution ink on the recording medium is jetted.

FIG. 7 is a top view showing a structure of a head unit for the other pattern than in FIG. 2.

FIG. 8 is a top view showing a structure of a head unit for yet another pattern.

FIG. 9 (a) is a diagram explaining ink jetting timing by a head unit while the rotation drum make a revolution in the second embodiment.

FIG. 9 (b) is a diagram explaining in what number of revolution ink on the recording medium is jetted in the second embodiment.

FIG. 10 is a diagram explaining in what number of revolution ink on the recording medium is jetted in the third embodiment.

FIG. 11 is a perspective view showing a schematic structure of a conventional drum type inkjet recording apparatus.

FIG. 12 is a view showing arrangement of a head unit of a conventional drum type inkjet recording apparatus.

FIG. 13 is a view showing arrangement of nozzles of a conventional drum type inkjet recording apparatus and explaining a recording method where nozzles in quantity N, N₁, N₂, N₃, to Nₙ(N is natural number) having a nozzle pitch of 1/Pt carry out recording image with printing resolution R_{z}.

FIG. 14 is a diagram explaining a recording method by a conventional drum type inkjet recording apparatus.

### DETAILED DESCRIPTION OF THE PREFERRED EMBODIMENT

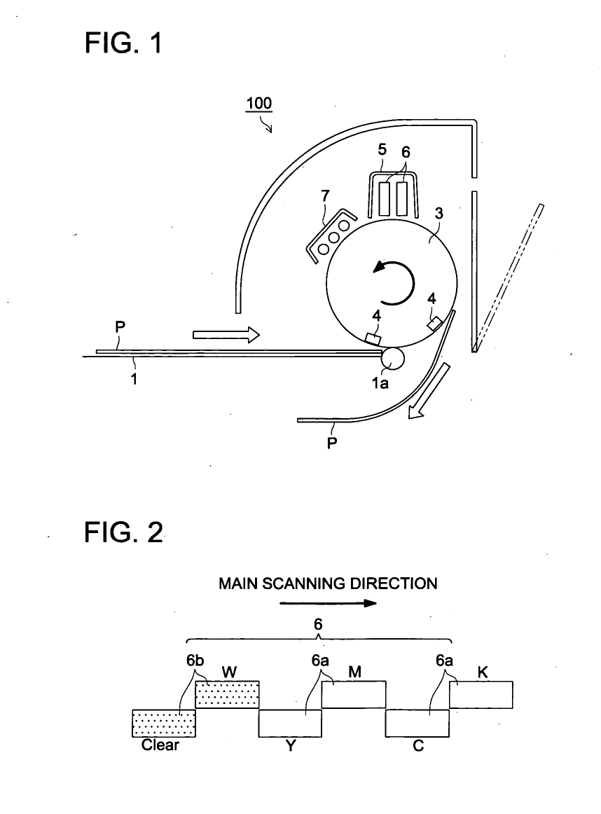

The first embodiment of the present invention is explained with reference to FIG. 1 to FIG. 10.

FIG. 1 is a schematic structural view of inkjet recording apparatus 100 of the present embodiment.

In inkjet recording apparatus 100, recording medium P is carried inside inkjet recording apparatus 100 where supporting member 1 to support recording medium P carried in is provided.

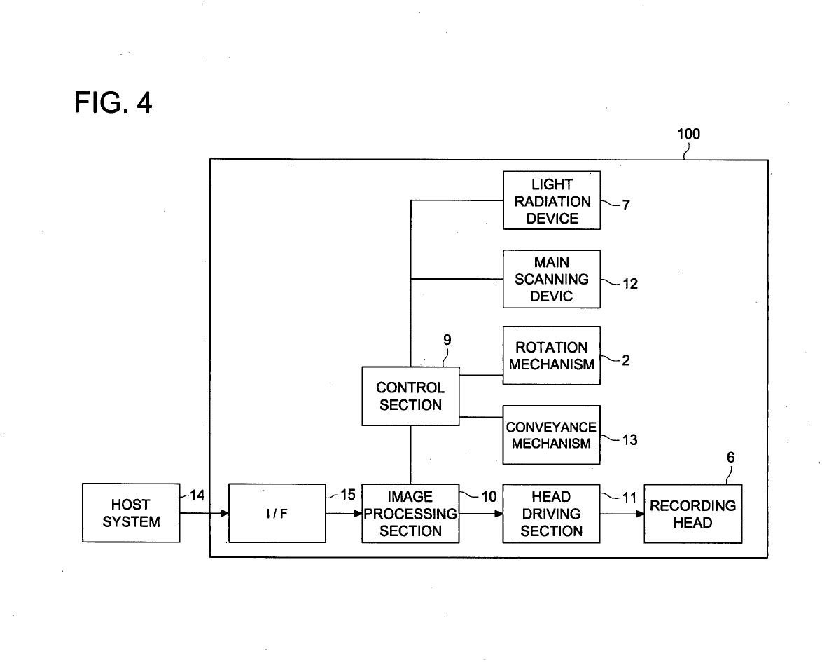

In supporting member 1, on an end of downstream side in a conveyance direction (sub-scanning direction) of recording medium P, roller la to convey recording medium P is arranged, and rotation drum 3 formed in drum shape and configured to be able to rotate by rotation mechanism 2 (refer to FIG. 4) described later is arranged to extend in its axis direction (hereinafter also called main scanning direction).

On a circumference surface of rotation drum 3, chucking mechanism 4 to pinch recording medium P is provided. Chucking mechanism 4 is composed of a pair of members which pinch an end of downstream side and an end of upstream side of recording medium in the conveying direction. When rotation drum 3 is rotated by rotation mechanism 2, recording medium P conveyed from sheet feeding tray 1 is pinched by the end of downstream side in the conveying direction, then recording medium P is pinched by the end of upstream side in the conveying direction as rotation drum 3 rotates. Thereby, recording medium P is retained being trained about on the circumference surface of rotation drum 3 by chucking mechanism 4. Meanwhile, a length of recording medium P in a conveyance direction applicable to inkjet recording apparatus 100 is shorter than that of the circumference of rotation drum 3.

Also, in a position opposite to the circumference surface of rotation drum 3, a pair of guide rails (unillustrated) extending in the main scanning direction are provided and head unit 5 is supported by the guide rails to be able to reciprocate in the main scanning direction.

Head unit 5 is provided with a plurality of recording heads 6,6, . . . to jet ink, and an ink jetting surface of recording head 6 is arranged to oppose to recording medium P on the rotation drum 3 and is adjusted so that ink jetted from recording head 6 lands in a prescribed area of recording medium P on rotation drum 3.

Here, the plurality of recording heads 6 are composed of image head 6a to jet process color ink representing ink for a real image and image head 6b to jet non-process color ink representing ink for a back ground. As FIG. 2 shows, a nozzle array is formed along the main scanning direction where the recording heads to jet clear (Clear) and white (W) ink as the non-process color, and the recording heads to jet yellow (Y), magenta (M), Cyan (C) and black (B) ink as the process color, are arranged zigzag in order.

For inkjet recording apparatus 100 of the present invention, light curable ink (radical polymer series ink, cationic polymer series ink and hybrid type ink are included) which is cured by irradiation of ultra violet ray radiation is preferably used. In the present embodiment, energy accumulation type cationic polymer series ink in which inhibition of polymerization reaction by oxygen seldom occur, capable of being cured by low intensity irradiation of ultra violet is particularly preferred to use.

Further, at a position opposite to the circumference surface of rotation drum 3, in downstream side of head unit 5 in the conveyance direction of recording medium P, a pair of guide rails (unillustrated) are provided and light radiation device 7 is supported by the guide rails to be able to reciprocate in the main scanning direction.

Light radiation device 7 having a light source inside is to radiate light capable of curing ink. As the light source, a fluorescent lamp, a mercury lamp and a metal halide lamp to radiate ultra violet, electron ray, X ray, visible light and infrared ray can be used. In the present embodiment ultra violet ray is used.

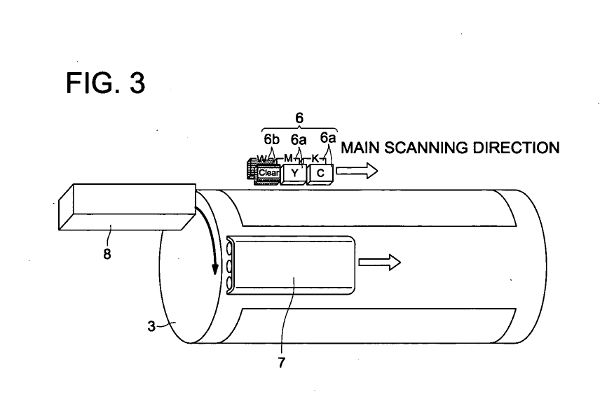

Also, on the side of rotation drum 3, maintenance unit 8 is provided. Here, as FIG. 3 shows, maintenance unit 8 is arranged on the left side in FIG. 3.

Next, configuration of control for inkjet recording apparatus 100 will be explained as follows.

As FIG. 4 shows, inkjet recording apparatus 100 is provided with control section 9. To control section 9, besides the aforesaid recording head 6 and light radiation device 7, image processing section 10, head driving section 11 to drive recording head 6, main scanning mechanism 12, rotation mechanism 2 and conveyance mechanism 13 are electrically connected so as to control and drive the aforesaid components respectively.

Through interface (I/F) 15, encoded input image data sent from host system 14 connected via a network, is decoded into a data form capable of being processed by inkjet recording apparatus 100 and sent to head driving section 11 by -image processing section 10. In host system 14, input operation is conducted to control total operation of inkjet recording apparatus 100 including selection of a printing resolution, besides sending image data for recoding to inkjet recording apparatus 100.

Based on a signal sent from control section 9, head driving section 11 controls ink jetting from nozzles of recording head 6 by applying plus voltage to a piezoelectric element of recording head 6 so that data related to recoding image obtained by image processing section 10 is recorded.

Main scanning mechanism 12 is provided with head unit 5 and a driving motor (unillustrated) to drive light radiation device 7. Head unit 5 and light radiation device 7 scan along the guide rail in the main scanning direction by controlling and driving this driving motor with control section 9. Main scanning mechanism 11 synchronizes head unit 5 and light radiation device 7 to scan in the main scanning direction. Ink jetted from recording head 6 of head unit 5 onto recording medium P can be irradiated by the light radiated from light radiation device 7 and can be cured.

Conveyance mechanism 13 is provided with conveyance rollers (unillustrated) and a conveyance motor (unillustrated) to drive and rotate in a periodic base so that recording medium P is conveyed into inkjet recording apparatus 100 by predetermined feeding amount. By driving and controlling the conveyance motor, recording medium P is conveyed inside one by one.

Rotation mechanism 2 is provided with a drive motor (unillustrated) to operate catching mechanism 4 which holds recording medium P on rotation drum 3 when a drive motor to drive rotation drum 3 at a predetermined revolution and rotation drum 3 reaches at a predetermined speed, and releases recording medium P after image recording. Control section 9 controls these drive motors so that rotation drum 3 rotates while recording medium P is being held on rotation drum 3.

Here, while rotation mechanism 2 constitutes the conveyance mechanism of inkjet recording apparatus 100, in the following explanation, conveyance of recording medium P by rotation mechanism 2 and that by other mechanisms are explained with making a distinction between them. A conveyance mechanism for recording medium P not by rotation mechanism 2 is explained as conveyance mechanism 13.

Control section 9 is composed of CPU, ROM and RAM (all unillustrated), and a process program stored in ROM is loaded to RAM to be executed by CPU.

Practically, control section 9 controls conveyance mechanism 13 to convey recording medium P in the sub-scanning direction and controls rotation mechanism 2 to rotate rotation drum 3.

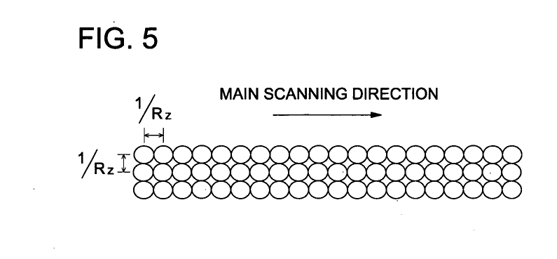

Here, control section 9 sends a command signal of printing resolution established in host system 14, and controls main scanning mechanism 12 to move head unit 5 and light radiation device 7 in a direction of axis of rotation drum 3 for a predetermined distance in every single revolution of rotation drum 3 in accordance with the established printing resolution, so that ink jetted from recording head 6 do not neighbor each other on recording medium P, and carries out next ink jetting action after these head unit 5 and light radiation device 7 move. As FIG. 5 shows, in practice, in case dots are formed on recording medium P with printing resolution R_{z} (dpi), if printing resolution R_{z} (dpi) established in host system 14 is greater than nozzle resolution Pₜ (dpi), control section 9 controls a moving distance of recording unit 5 and light radiation device 7 in the main scanning direction per revolution of rotation drum 3 (i.e. intermittent feed amount) so that the intermittent feed amount becomes greater than 1/Pₜ.

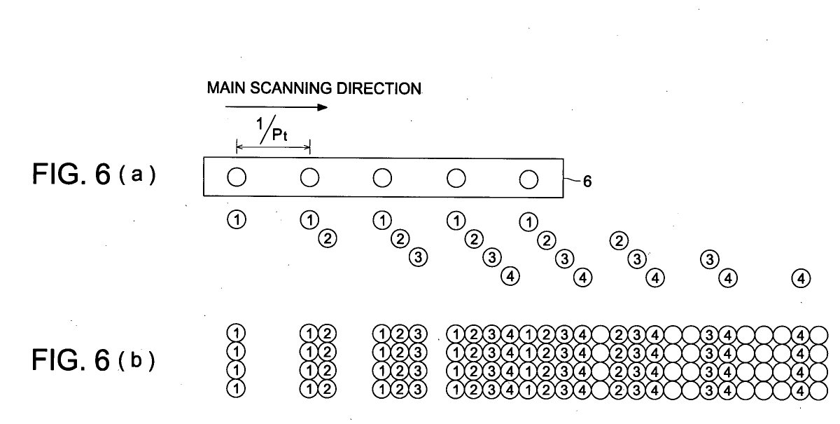

For example, as FIG. 6 (a) shows, control section 9 controls head unit 5 so that head unit 5 moves a distance longer than the nozzle pitch in every single revolution of rotation drum 3, in other words, a distance longer than 1/Pₜ. In the following explanation, dots are represented by 0 and numerals in 0 indicate in which revolution the dots are formed on recording medium P until rotation drum 3 revolve 4 times. While repeating the aforesaid operation, control section 9 controls scanning from one end to the other end in the main scanning direction, thus at least more than one dot can be formed within the nozzle pitch.

In this way, it can be applied to a case where printing resolution R_{z} (dpi) is greater than nozzle resolution Pₜ (dpi), and it is prevented that the dots jetted from the same nozzle neighbor each other on recording medium P in the main scanning direction while the dots are filling the nozzle pitch. Meanwhile, in this case, at both ends in the main scanning direction, there are respectively formed ink jetting starting and ending areas where ink is not jetted corresponding to output data obtained by image processing section 10 so that recording can start from a position which is thoroughly filled by pixels and an image is formed appropriately on recording medium P.

Also, control section 9 sends command signals such as the printing resolution established in host system 14 and a driving frequency to head driving section 11, and causes a plus voltage to be applied from head driving section 11 to the piezoelectric element of recording head 6 based on prescribed image recording information then controls ink jetting from nozzle of recording head 6 in a predetermined cycle.

Next, operation of inkjet recording apparatus is explained. In host system 14, when a printing resolution is inputted and input image data is sent from host system 14 to image processing section 10 through I/F 15, control section 9 controls rotation mechanism 2 to rotate rotation drum 3.

Then, when rotation drum 3 reaches at a predetermined revolution speed, conveyance mechanism 13 is controlled to convey recording medium P onto supporting member 1. After that, when a front edge of recording medium P reaches at roller 1a, recording medium P is pinched by chucking mechanism 4 and retained on a circumference surface of rotation drum 3. Then recording medium P is rotated along with rotation of rotation drum 3.

Then control section 9 controls head driving section 11 based on image data inputted by image processing section 10.

At this stage, control section 9 controls the nozzles to be used so that the dots jetted from the same nozzle do not neighbor each other on recording medium P. Here, if printing resolution R_{z} (dpi) established in host system 14 is greater than nozzle resolution Pt (dpi), control section 9 controls a moving distance of recording head 6 per revolution of rotation drum 3 (i.e. intermittent feed amount) so that the intermittent feed amount becomes greater than 1/Pₜ.

In other words, firstly control section 9 controls to jet ink from the nozzles while rotation drum 3 rotates in a predetermined speed, in other words a predetermined feeding amount per unit time. Then light radiation device 7 radiates ultra violet ray along with rotation of rotation drum 3 to quickly cure the ink on recording medium P. Thus ink is in hardened condition on recording medium P. Then when recording medium P comes to a position where recording head 6 does not oppose or comes outside of an image forming area, head unit 5 is moved a predetermined distance in the main scanning direction. In this period, rotation drum 3 continues to rotate in the predetermined feeding amount. After that, when head unit 5 again come to a position where head unit 5 opposes recording medium P, ink is jetted form the nozzle. In this way, controls section 9 moves head unit 5 a distance longer than the nozzle pitch per revolution of rotation drum 3 and repeats this action while scanning is being carried out from one end to the other end in the main scanning direction. As a result, as FIG. 6 (b) shows, at least more than one dot can be formed within the nozzle pitch and this can be adapted to a case where the printing resolution is greater than the nozzle resolution, then it can be prevented that the dots jetted form the same nozzle neighbor each other on recording medium P in the main scanning direction.

After that, when one scanning stroke in the main scanning direction is completed, image recording is applied over a width of recording medium P and image recording is terminated. Then recording medium P is released from chucking mechanism 4 and recording medium P on which an image is recorded is collected. p Meanwhile, maintenance of recording head 6, such as blank jetting and wiping is carried out arbitrary.

As above, according to inkjet recording apparatus 100 of present embodiment, even if the printing resolution is greater than the nozzle resolution, it can be prevented that the dots jetted from the same nozzle neighbor each other on recording medium P in main scanning direction by controlling the intermittent feeding amount in this manner, and a high-resolution image can be obtained.

Also, in the present embodiment, while light radiation device 7 is formed to correspond with head unit 5 and moves synchronously with head unit 5, light radiation device 7 may be formed to have a size corresponding to a width of rotation drum 3 in the main scanning direction.

Further, in the present embodiment, it is not necessary to form recording head 6 in which the nozzles are formed over a width of recording medium P, because ink jetting is conducted while head unit 5 is being moved in relation to rotation drum 3 in the main scanning direction.

Also, while chucking mechanism 4 is a mechanism to retain recording medium P by pinching, a structure where static electricity is generated to be able to adhere recording medium P onto rotation drum 3 or a structure where recording medium P is adhered onto rotation drum 3 by vacuum may be utilized.

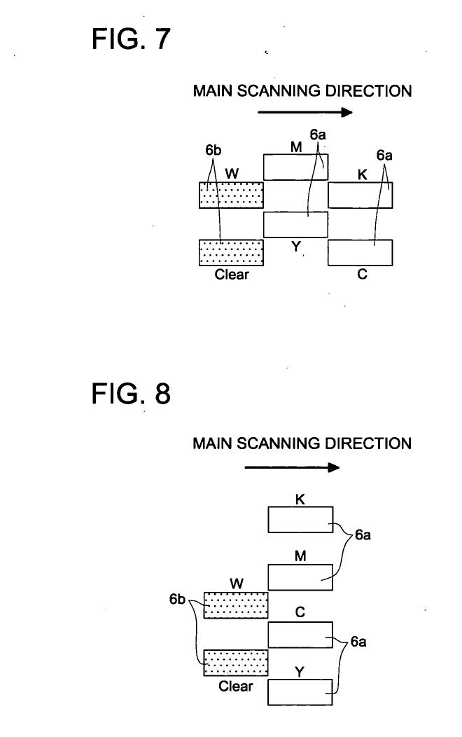

Also, besides a pattern shown by FIG. 2, as allocation patterns for image head 6a and for background head 6b, allocation patterns shown by FIG. 7 and FIG. 6 may be possible.

In FIG. 7, in the same manner as FIG. 2, a recording head to jet non-process color and a recording head to jet process color are arranged along the main scanning direction in order, and a first head unit in which white (W), magenta (M) and black (B) are arranged zigzag in order is arranged, and a second head unit in which clear (Clear), yellow (Y) and cyan (C) are arranged zigzag in order is arranged parallel to the first head unit, thereby forming head unit 5.

In FIG. 8, in the same manner as in FIG. 2 and FIG. 7, a recording head to jet non-process color and a recording head to jet process color are arranged along the main scanning direction, and a third head unit in which the recording heads to jet process colors are arranged parallel each other and a fourth head unit in which the recording heads to jet non-process colors are arranged parallel each other are arranged to form head unit 5.

Also, in the present embodiment, while an example where in case printing resolution R_{z} (dpi) is greater than nozzle resolution Pₜ (dpi), control section 9 controls recording head 6 so that moving distance (intermittent feeding amount) of recording head 6 in the main scanning direction per rotation of rotation drum 3 becomes greater than 1/Pₜ has been explained, in case printing resolution R_{z} (dpi) is the same as nozzle resolution Pₜ (dpi), control section 9 may control timing of ink jetting so that recording medium P is filled with the dots in circumference direction of the rotation drum 3 by jetting ink from recording head 6 with predetermined intervals while rotation drum 3 rotates a plurality of times.

Next, as a second embodiment, an embodiment where printing resolution R_{z} (dpi) and nozzle resolution Pₜ (dpi) are equal is explained.

The inkjet recording apparatus is configured in the same manner as the first embodiment except for a configuration of control section. Here, in case printing resolution R_{z} (dpi) is equal to nozzle resolution Pₜ (dpi), the control section is configured to jet ink from recording head 6 with a predetermined interval and to control the ink jetting timing so that recording medium P is filled by dots in the circumference direction of the rotation drum after the rotation drum is rotated a plurality of times.

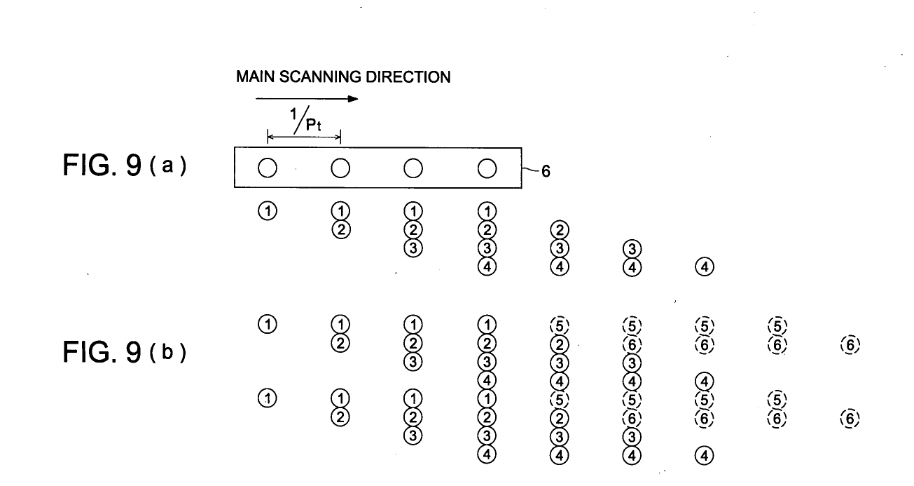

For example, in case a recording head having nozzles in quantity of N (N is natural number and not less than 2) is used to record a desired image on recording medium P, as FIG. 9(a) shows, recording head 6 is controlled so that ink is jetted from the nozzles with an interval of N−1 dots while rotation drum is rotating at a predetermined revolution speed. Then when the rotation drum makes one turn, the control section moves the head unit by one nozzle pitch 1/Pₜ in the main scanning, after that, starting timing of jetting ink from nozzle is electrically delayed by one dot, then again in the same manner, ink is jetted with an interval of N−1 dots. Then when the rotation drum completes revolutions N times, as FIG. 9 (b) shows, head unit is moved by nozzle resolution 1/Pt in the main scanning direction, after that at the ink jetting position in the first revolution of the rotation drum in circumference direction, ink jetting is started again and ink is jetted from the nozzles with the interval of N−1 dots. In this way, the head unit is displaced in the main scanning direction. This action is repeated until an image filled with the dots in the main scanning direction is completed.

Next, operation of an inkjet recording apparatus having control configured in the above is explained.

Recording medium P is conveyed into recording apparatus by receiving input form the host system, then recording medium P is held by the rotation drum which is rotating at a predetermined rotation speed and opposes to the head unit. The control section controls the ink jetting timing so that recording medium P is filled by the dots in the circumference direction of the rotation drum after a plurality of revolutions of the rotation drum.

First, as FIG. 9 (a) shows, the control section controls recording head 6 to jet ink with the interval of N−1 dots (N is not less than 2 and natural number), then after the rotation drum rotates once, the head unit moves by a nozzle pitch. And after starting timing of ink jetting is delayed electrically by one dot, ink is jetted from the nozzles with the interval of N−1 dots. Then when the rotation drum completes revolution N times, the head unit moves by nozzle pitch 1/Pt in the main scanning direction, after that the same position as the ink jetting position in the first revolution of the rotation drum in the circumference direction, ink jetting is started again and ink is jetted from the nozzles with the interval of N−1 dots. From now onward, this action is repeated until an image filled with dots in the main scanning direction is completed.

In this operation, as FIG. 9(b) shows, the control section forms the dots with a predetermined distance in the circumference direction of the rotating drum and dots in quantity of N−1 are formed between the dots which are formed in the circumference direction of rotation drum 3 while rotation drum 3 makes one revolution.

Therefore, the adjacent dots can be formed in different turn of the rotation drum nozzles and it can be prevented that adjacent dots on recording medium P are jetted from the same nozzle to obtain a high-resolution image.

Further, in case the printing resolution is greater than the nozzle resolution Pt (dpi), as a third embodiment there is an embodiment, wherein operation in control section is a combination of the first embodiment and the second embodiment, intermittent feeding action is conducted in the same manner as in the first embodiment and ink jetting timing action in the rotation drum circumference direction (rotation direction) is conducted in the same manner as the second embodiment.

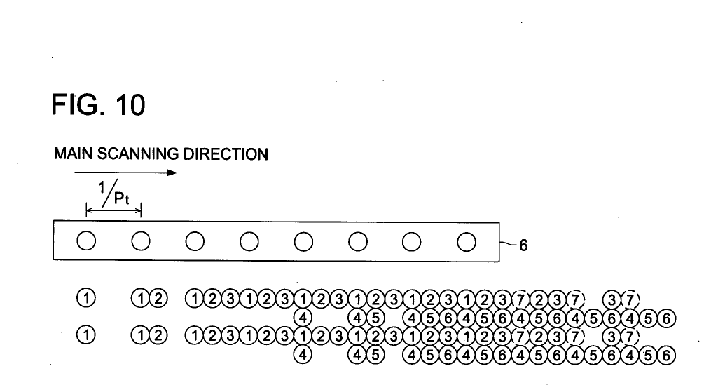

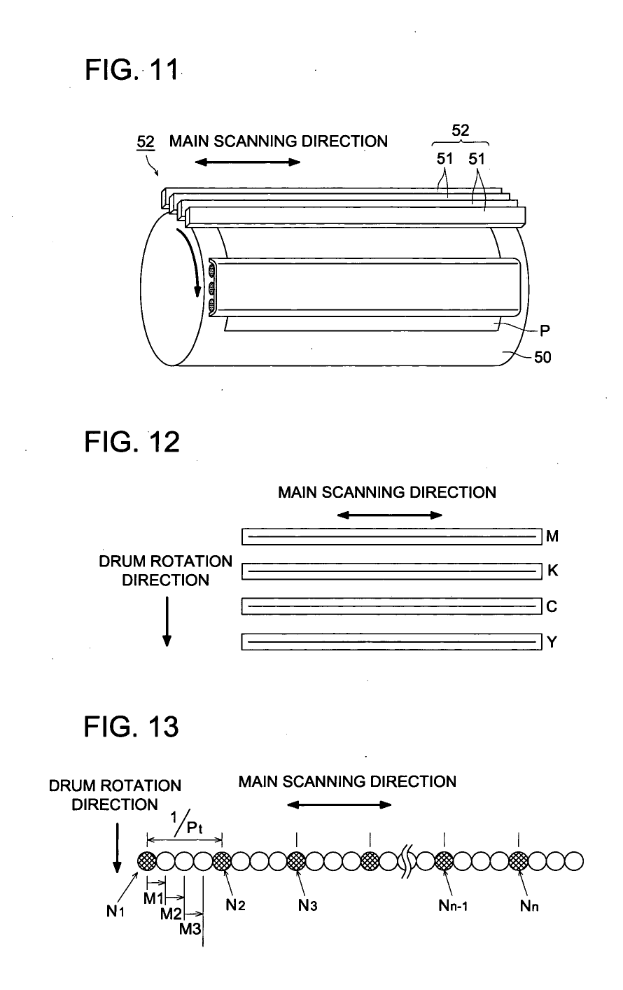

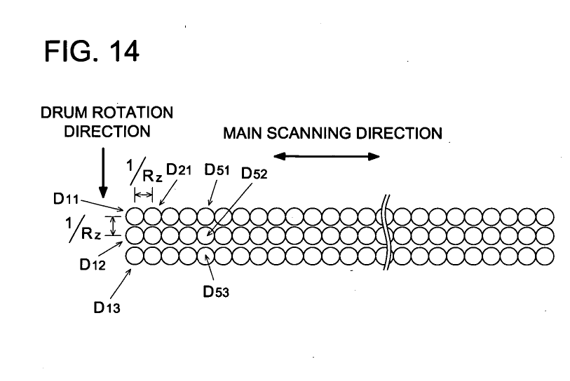

Namely, as FIG. 10 shows, the control section controls so that a moving distance (intermittent feeding amount) of recording head 6 per revolution of the rotation drum in the main scanning direction is greater than 1/Pt and controls the ink jetting timing so that recording medium P on rotation drum 3 is filled with the dots by jetting ink from recording head 6 with a predetermined interval while the rotation drum is rotating a plurality of times.

Meanwhile, in the example of FIG. 10, the dots formed on recording medium is represented by circles and numerals in the circles indicate in which revolution of the rotation drum the dot is formed. In the example of the FIG. 10, the dots are formed with an interval of one dot in the rotation direction of the rotation drum and in the main scanning direction, nozzle head 6 having eight nozzles moves intermittently by a pitch greater than nozzle pitch 1/Pₜ (dpi). After 6 revolutions of the rotation drum, recording medium P is filed with the dots in the rotation direction and the main scanning direction. From seventh revolution onward, the dots are form in the same position in rotation direction as the first revolution so that blanks are filed by the dots. As above, intermittent feeding with the predetermined interval conducted in the main scanning direction and operation to electrically adjust a starting position for forming the dots are repeated so as to form an image.

Meanwhile, a distance between dots in the rotation direction and the resolution in main scanning direction are not limited to the examples in the figures.

Next, operation of an inkjet recording apparatus configured in the above way is explained.

Recording medium P is conveyed into recording apparatus by receiving input form the host system, and recording medium P held by the rotation drum which is rotating at a predetermined rotation speed, opposes to the head unit. Then the control section controls the head driving section to jet ink from recording head 6 based on image data inputted through the image processing section.

At this stage, the control section controls the nozzles used for ink jetting and ink jetting timing so that the same nozzle does not jet ink to form adjacent dots on recording medium P, and controls the moving distance (intermittent feeding amount) of recording head 6 per revolution of the rotation drum in the main scanning direction to be greater than 1/Pt, thereby recording medium P is filled with the dots in the rotation direction of the rotation drum while the rotation drum rotates a plurality of times.

Namely, the control section controls recording head 6 so that ink jetted from the nozzle forms dots with an interval of one dot while the rotation drum is rotated in a predetermined feeding amount. Simultaneously, the control section controls the light radiation device. Along with rotation of the rotation drum, ultra violet ray is radiated from the light radiation device so as to quickly harden the ink on recording medium P.

Then, when the rotation drum makes one revolution, the head unit is intermittently fed in the main scanning direction by a pitch greater than nozzle pitch 1/Pt (dpi) and ink is jetted again to form the dots with the interval of one dot. This operation is repeated until the rotation drum rotates six times. Thereby, within the dots to be formed on the recording medium, the dots in the circumference direction of the rotation drum are formed.

Then from the seventh revolution, ink jetting is started from a blank position which is in line in the main scanning direction with a position where ink jetting is started at first revolution and after that ink is jetted to form the dots in the circumference direction of the aforesaid rotation drum with the intervals of one dot, then intermittent feeding of the head unit by a pitch greater than nozzle pitch 1/Pₜ (dpi) in the main scanning direction is repeated six times. And then, the same operation as after the seventh revolution is repeated from thirteenth revolution onward.

Namely, from the seventh revolution onward, after every six revolutions of the rotation drum, ink jetting starts at the position which is in line with the position where the ink is jetted in the first revolution in the main scanning direction and the successive ink jetting operation is conducted to fill the blanks where the dots are not filled.

As the result, as FIG. 10 shows, both in the main scanning direction and in the circumference direction of the rotation drum, the dots can be formed with a predetermined interval on recording medium P, and it is prevented that the same nozzle jets ink to form the adjacent dots even in case the printing resolution is greater than nozzle resolution Pₜ (dpi) both in the main scanning direction and in the circumference direction of the rotation drum 3 to obtain a high-resolution image.

Meanwhile, with the first embodiment to the third embodiment, while image forming apparatuses having small quantity of nozzles in the recording head have been explained, application of the present invention is not restricted by the number of the nozzle. The present invention can be applied to such conventional nozzle head as shown in FIG. 1 where the nozzles in the recording head are arranged over the width of the recording medium. In other words, it can be applied to a line head type recording head where ink jetted form the nozzles can cover a whole length of the rotation drum in an axis direction representing a width of the recording medium. And in this case, in addition to the nozzles provided on the recording head to cover a length equal to a total length of intermittent feeding carried out in the main scanning direction and to cover whole length of the rotation drum in the axis direction along the main scanning direction, extra nozzles to be provided to realize it.

Meanwhile, so as to complete an image having desired printing resolution where the all the dots to be formed on the recording medium are filled by rotating the rotation drum N times (N is a natural number), a quantity M of the extra nozzles formed on the recording head is an integer value obtained from round down of K satisfying the following formula.
K =2 ×((N−1)×intermittent feeding amount/nozzle resolution (Pₜ))

According to the aforesaid embodiment, since the adjacent dots on the recording medium in the axis direction of the rotation drum are formed by the ink jetted from different nozzles to carry out recording, deterioration of particle of image on the recording medium caused by occurrence of strip-shaped unevenness or lines due to nozzle failure and sticking between adjacent dots in the circumference direction of the rotation drum is prevented, and thus a high-resolution image can be obtained.

Even in case the printing resolution is greater than the nozzle resolution, control section can prevent that the adjacent dots on the recording medium are formed by ink jetted form the same nozzle, and thus the high-resolution image can be obtained.

Also, in case the printing resolution is the same as the nozzle resolution, it can be prevented that the adjacent dots on the recording medium are formed by ink jetted form the same nozzle, and thus the high-resolution image can be obtained.

Also, it can be prevented that the adjacent dots on the recording medium are formed by ink jetted form the same nozzle, and thus the high-resolution image can be obtained.

Also, ink can be hardened while the rotation drum is consecutively rotating, thus a productivity is improved.

And also, a productivity is improved.

What is claimed is:

1. An inkjet recording apparatus, comprising: a rotation drum to rotate while retaining a recording medium on a circumference surface of the rotation drum;
a recording head including a plurality of nozzles which are opposite to the circumference surface of the rotation drum and arranged along an axis direction of the rotation drum to jet ink,
a control section to control rotation of the rotation drum and ink jetting operation, wherein the recording head moves by a predetermined distance in the axis direction of the rotation drum in every single revolution of the rotation drum before ink jetting operation in subsequent revolution so that ink jetted from each nozzle does not neighbor on ink jetted from the same nozzle in the axis direction of the rotation drum.

2. The inkjet recording apparatus of claim 1, wherein while a nozzle resolution is P_{T} (dpi), a moving distance of the recording head in every single revolution of the rotation drum is not less than 1/Pₜ.

3. The inkjet recording apparatus of claim 1, wherein while a nozzle resolution is P_{T} (dpi), a moving distance of the recording head in every single revolution of the rotation drum is more than 1/Pₜ.

4. The inkjet recording apparatus of claim 1, wherein ink jetting timing is controlled so that the recording medium on the rotation drum is filled with dots in a circumference direction by jetting ink from the recording head with a predetermined interval, while the rotation drum rotates a plurality of times.

5. The inkjet recording apparatus of claim 1, wherein the ink jetted from the nozzles is light-curable ink and a light radiation device is provided above the circumference surface of the rotation drum to harden ink jetted onto the recording medium.

6. The inkjet recording apparatus of claim 1, wherein the recording head moving operation in the axis direction of the rotation drum is conducted above the circumference surface of the rotation drum where the recording medium is not retained.
